(19) United States
(12) Patent Application Publication
(10) Pub. No.: US 2005/0279445 A1
(43) Pub. Date: Dec. 22, 2005

(54) Thermal applique text

(76) Inventors: Paula Shemanski, Baltimore, MD (US); William Bensel, York, PA (US)

Correspondence Address: ROYAL W. CRAIG;A PROFESSIONAL CORPORATION, 10 NORTH CALVERT STREET, SUITE 153, BALTIMORE, MD, 21202, US

(21) Appl. No.: 11/121,749

(22) Filed: May 3, 2005

Related U.S. Application Data
(60) Provisional application No. 60/567,577, filed on May 3, 2004.

(51) Int. Cl. B29C 70/52

(52) U.S. Cl. 156/166

(57) ABSTRACT

A product and process for applying thermal appliqué indicia which results in decorative and identification elements that are an alternative to direct embroidery and embroidered emblems. The thermal appliqué indicia are for decoration and identification when applied to uniforms, fashion, “basic” and performance apparel, swimwear and intimate apparel as well as other textile products. They give the appearance of a directly embroidered monogram design that remains light and very flexible with excellent home or commercial laundering, and may be single or multi-colored and contain many discreet parts that require precise registration and maintenance of special relationships on the garment or textile.

### CROSS-REFERENCE TO RELATED APPLICATIONS

The present application derives priority from U.S. Provisional Application No. 60/567,577 filed May 3, 2004.

### BACKGROUND OF THE INVENTION

1. Field of the Invention

The present invention relates to an embellishment method for providing appliqué text, logo graphics, numbers or other indicia to the uniform industry and other textile industries by thermal application directly onto garments, apparel, and accessories, for identification, decoration, trademarking or otherwise embellishing the final product, thereby eliminating the need for screen-printing, heat transfers, direct embroidery or embroidered name emblems.

2. Description of the Background

Fashion, “basic” and performance apparel, uniform, swimwear and intimate apparel and accessory manufacturers use various methods to apply decoration and identification to garments and textiles. They tend to use silk-screening, screen-printing, sonic welding and direct embroidery as their primary methods for decorating and identification.

Silk-screening of logos or emblems is commonly used, but this process is complex and time-consuming. In addition, the designs created by silk-screening are flat, lack textured and do not withstand repeated industrial or home washings. Consequently, many companies prefer embroidery as their primary method for applying decoration and identification.

Sonic welding is another method used to apply decoration and identification to garments and textiles. This process requires the creation of unique, expensive special dies for any design to be applied. The quick-change requirements associated with the fashion industry make this process slow and relatively expensive. Sonic welding allows texturing, but also requires chemical compounds that some companies find unacceptable, and that can result in a product that does not stand repeated home and industrial laundering. Indeed, this process typically is not used by the uniform industry for these reasons. Embroidery has instead become the primary method for applying decoration and identification.

Embroidery is typically performed by a machine that applies stitching of various colors and styles to fabric to create a design. Embroidered designs have a much greater aesthetic value, and yet this too is a complex, time-consuming process. A separate stitching step is required for each color in the design and for each design element.

U.S. Pat. No. 5,009,943 to Stahl discloses a method for producing a multi-colored emblem that may be ironed-on to garments to provide an embroidered appearance. This method entails laminating a material blank, cutting the laminated material to a specific design, embroidering about the periphery of the cut design, laminating the assembly onto a second material blank, and coating the underside with a thermal adhesive layer. The emblem can then be heat-sealed to a garment. Despite the ability to give a realistic embroidered look, emblems produced using Stahls' method are relatively large, bulky and inflexible. Products manufactured under this process are also not capable of providing discreet registered elements that maintain their spatial relationship and are commercially launderable. While this may not be a problem for a heavy cotton shirt, the uniform and apparel industries are tending to move toward lighter fabrics where a heavy embroidered emblem looks out of place. The weight and bulk also creates noticeable discomfort to the wearer, especially if the emblem bears a lengthy name such as “Theresa” or the like. Moreover, due to the difficulty in manufacturing, placing and applying an embroidered emblem with numerous discontinuous elements, it is typical to stitch text or names as a single design comprising multiple separate or joined letters or numbers and then cutting a carrier around them for future application to the garment. This method is distinctly unsuitable for creating a product that has discreet elements with the requirement of having a specific spatial relationship amongst them.

There is no current method by which one can consistently manufacture and apply non-connected elements such as letters, logo graphics and numbers or other indicia in a form that is easily applied to a garment or other textile so that all of the elements are precisely registered relative to each other without using direct embroidery.

### SUMMARY OF THE INVENTION

It is, therefore, the primary object of the present invention to provide a novel method for producing thermal appliqué text, numbers, logos and other indicia for the uniform and other industries that serves as an embroidery replacement in giving a monogrammed appearance comprising discrete precisely registered text or numbers that maintain there spatial distribution.

It is another object to provide thermal appliqué text, numbers, logos and other indicia capable of being heat sealed to a garment or other article that, when so secured, creates a new form of decoration that appears to be part of the garment that is soft, light, very flexible, and yet very durable for repeated home and industrial launderings. The appliqué indicia can also be removed allowing a rental uniform to be reused.

It is another object to provide thermal appliqué indicia as described above which is especially suited for application to performance micro fiber garments and will emulate the stretch and recovery properties of the base garment material.

It is yet another object to provide thermal appliqué indicia as described above that eliminates uncomfortable embroidery threads and stabilizers on the garment underside, next to the skin.

It is still another object to provide thermal appliqué text, numbers, logos and other indicia comprising discrete, precisely registered letters, numbers or other forms that retain their spatial relationship that is easy to apply, and available to the uniform, fashion, basic and performance apparel, swimwear and intimate apparel industries in a variety of poly-based substrates and with “font diversity”, allowing for scalable representations of text ranging from very small (dimensions as low as 1 mm) letter and/or numbers through as large as a user might require.

According to the present invention, the above-described and other objects are accomplished by a product and process for applying thermal appliqué indicia which results in decorative and identification elements that are an alternative to direct embroidery and embroidered emblems. The thermal appliqué indicia are for decoration and identification when applied to uniforms, fashion, “basic” and performance apparel, swimwear and intimate apparel as well as other textile products. The thermal appliqué indicia is capable of being heat sealed to a garment or other article and, when so secured, should give the appearance of a directly embroidered monogram design that remains light and very flexible with excellent home (as defined in AATCC test procedure 135-2003) or commercial laundering (as defined AATCC in test procedure 96-2001) durability. The thermal bonding process eliminates the need for sewing or other bonding processes. The decoration or identification may be single or multi-colored and contain many discreet parts that require precise registration and maintenance of special relationships on the garment or textile.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective view of appliqué indicia formed on a carrier in accordance with the present invention in raw form.

FIG. 2 is a perspective view of the two carriers and release liner sealed together in an envelope to protect the indicia and maintain registration.

FIG. 3 is a perspective view showing the indicia after it has been thermally bonded to the fabric.

FIG. 4 is a perspective view showing the carrier and release liner after the indicia has been thermally bonded to the fabric.

FIG. 5 is a block diagram of the method of the present invention.

### DETAILED DESCRIPTION OF THE PREFERRED EMBODIMENT

The present invention is a method for providing thermal appliqué text for the uniform, other garment and accessory industries and creating a new form of decoration and identification that appears to be part of the garment and that delivers discreet letters, numbers, graphics and other indicia in a form that preserves their spatial relationship during thermal application directly onto a garment, thereby eliminating embroidered name blanks or direct embroidery. The invention delivers a single or multi color woven, non-woven or knit name or other design element with precisely registered components that can consistently be applied to the garment using a thermal bonding process. The resulting design element/garment can be industrially laundered.

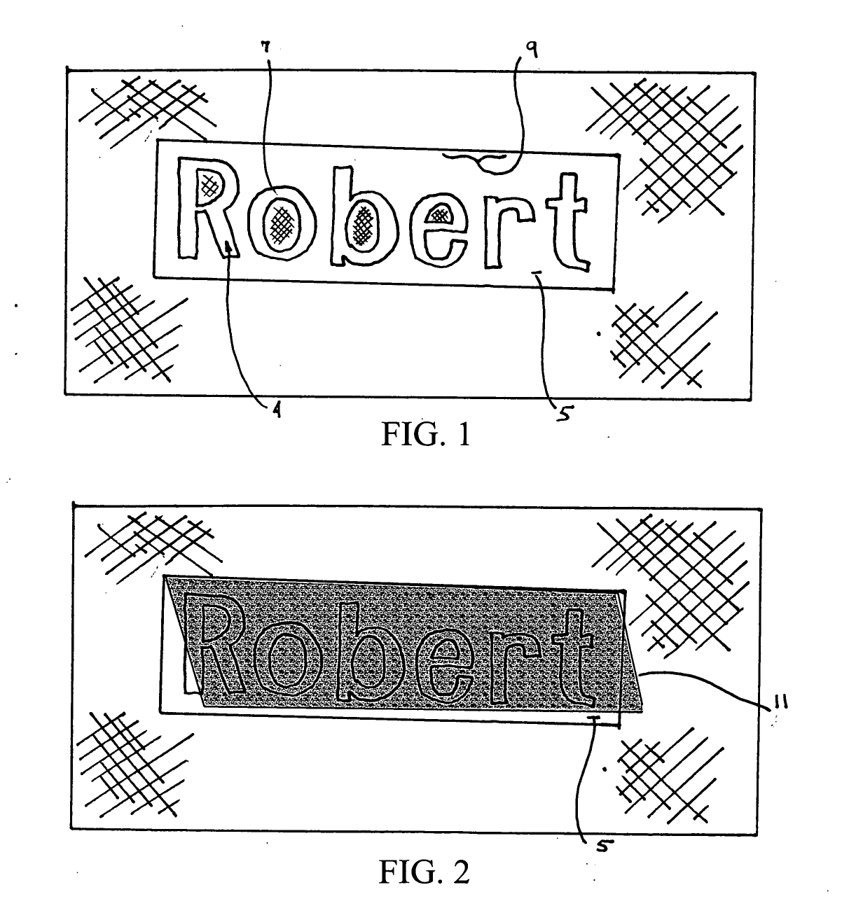

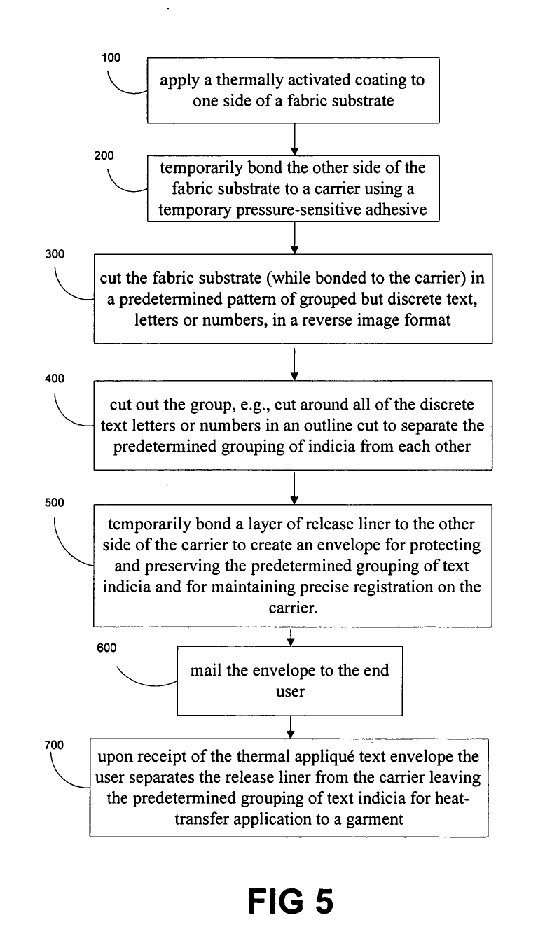

The method for providing thermal appliqué text is formed by the following steps 100-700, as illustrated in the block diagram of FIG. 5 with combined referenced to the perspective drawings of FIGS. 1-4.

The method begins at step 100 with a fabric substrate 4 that, in the preferred embodiment, is comprised of the chosen material with an appropriate thermally activated coating applied. The objective is to have an appropriate lightweight, flexible and stretchable blend. One skilled in the art will understand that the fabric substrate may be any woven, non-woven or knit fabric as a matter of design choice, provided that the qualities of fabric substrate are consistent with those of the clothing article so as not to detract there from. One skilled in the art would also recognize that the thermally activated coating would be one that has been chosen to work well with the fabric substrate, fit the manufacturing process, work with the selected garment and provide the required performance characteristics after bonding for customer end use.

At step 200, the uncoated side of the section of fabric substrate 4 is temporarily bonded to a carrier 5 using a temporary pressure-sensitive adhesive. At step 300, the fabric substrate 4 on carrier 5 is cut into the predetermined pattern that may include discrete names, letters, numbers, graphics, logos or other indicia 7 in a reverse image. FIG. 1 illustrates an exemplary cut pattern of discrete letters forming the name “Robert.”

After cutting the pattern, at step 400 an outline cut 9 is made to separate the complete indicia groupings from each other. At this time any interior pieces such as the center of an “O” can also be cut through if desired. Cutting may be accomplished using a laser cutter, hot knife or any other device capable of cutting through one or mare layers of material without cutting through the carrier. Laser cutting results in the cleanest most aesthetically pleasing cut, and suitable laser-cutting equipment is commercially available from Epilog Laser, 500 Corporate Cr, Suite L, Golden, Colo. This laser cutting equipment allows the pattern to be mapped in CorelDRAW or any similar graphics package, and then exported to the laser for a professional, cleanly seared cut. The outline cut can be accomplished using any available technology, although the laser can complete both cutting operations in sequence.

At this point the skeleton and any excess interior materials, such as the piece in the center of an “O”, are removed and discarded.

At step 500, and with reference to FIG. 2, a layer of release liner 11 is temporarily bonded to the carrier layer 5 to create an envelope that protects and preserves the text/letter/other element combination that has been cut and is precisely registered on the carrier. FIG. 2 is a perspective view of the carrier 5 and release liner 11 sealed together in an envelope to protect the Text and maintain registry. If required, the user demarcates the carrier with horizontal and vertical gridlines or centering registration marks to assist in final application alignment.

At step 600, the envelope with indicia may be conveniently mailed or otherwise sent in envelope form to the final user.

Upon receipt of the envelope, the user at step 700 separates the release liner 11 from the carrier 5 leaving the decorative and/or identifying elements 7 bonded to the carrier 5. With the aid of grid lines, centerlines or other placement devices the user applies the indicia to a garment 12 or any other textile product.

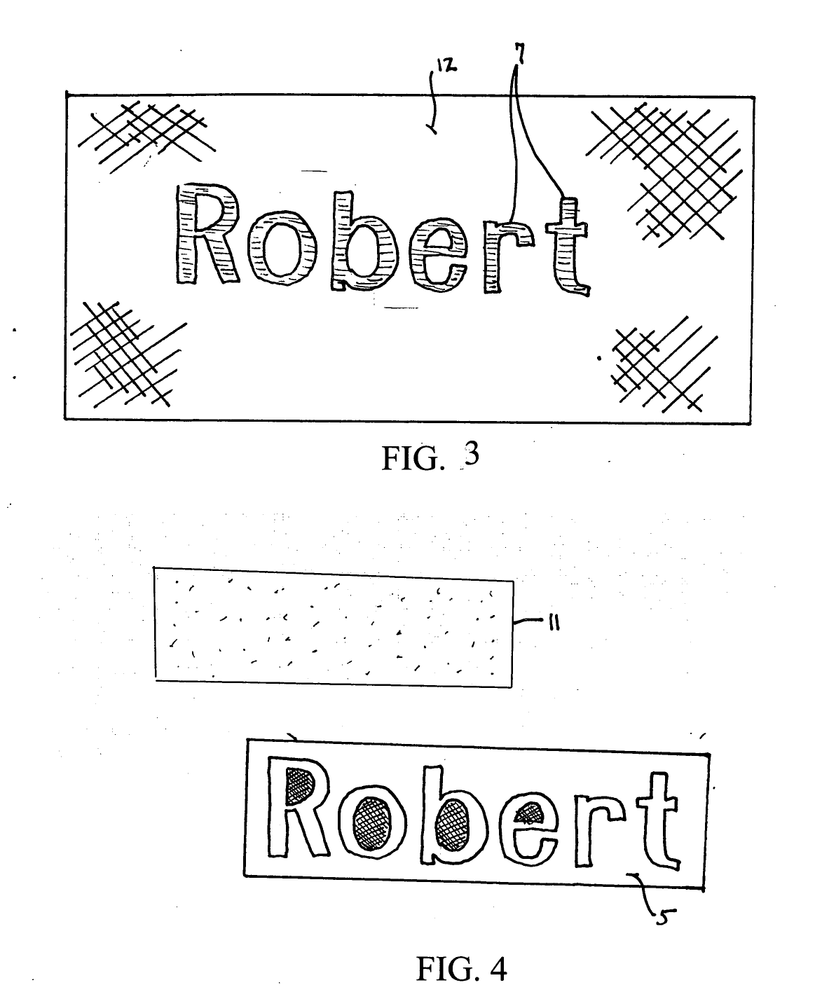

The heat-sensitive laminate allows the emblem to be applied to garments and, as seen in FIG. 3, and presents a distinct monogrammed appearance. The lightness of the fabric substrate results in an indicia that may appear recessed when thermally bonded to the fabric.

FIG. 4 shows the carrier and release liner after the indicia 7 has been bonded to the garment (as in FIG. 3), allowed to cool and the carrier carefully pealed away.

The foregoing thermal appliqué text is well suited for the uniform, apparel and accessory industries as it provides a convenient way to effectively provide a replacement for direct embroidery or traditional emblems and leaves a true registered image on the garment that gives the appearance of direct embroidery. The thermal appliqué indicia can be shipped to the garment manufacturer for thermal application on site. As seen in FIG. 3, the text has an excellent aesthetic, simulating an embroidered design, and it remains light and very flexible.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A method for providing discrete thermal appliqué indicia in a form that preserves their spatial relationship for thermal application directly onto a garment, comprising the steps of:
applying a thermally activated coating to a fabric substrate;
bonding the uncoated side of the fabric substrate to a carrier;
cutting the bonded fabric substrate and carrier into the predetermined pattern that consists of discrete names, letters, numbers, graphics, logos or other indicia in a reverse image;
cutting the bonded fabric substrate and carrier in an outline cut;
removing excess materials from said cutting steps;
bonding a layer of release liner to the carrier layer to create an envelope that protects and preserves the cut indicia in a precisely registered relationship on the carrier;
sealing the carrier and release liner sealed together in an envelope to protect and maintain registry.

2. The method of claim 1, wherein said carrier comprises horizontal and vertical gridlines for assisting with registration during said user application.

3. The method of claim 1, further comprising a sixth step of mailing said envelope with indicia to the user.

4. A method for providing thermal appliqué text, comprising:
a first step of applying a thermally activated coating to one side of a fabric substrate;
a second step of temporarily bonding another side of said fabric substrate to one side of a carrier using a temporary pressure-sensitive adhesive;
a third step of cutting the fabric substrate on said carrier in a predetermined pattern comprising predetermined grouping of discrete text letters or numbers in a reverse image format;
a fourth step of cutting around all of said discrete text letters or numbers in an outline cut to separate said predetermined grouping of indicia from each other;
a fifth step of temporarily bonding a layer of release liner to another side of said carrier to create an envelope for protecting and preserving said predetermined grouping of text indicia and for maintaining precise registration on said carrier;
whereby upon receipt of the thermal appliqué text a user separates the release liner from the carrier leaving the said predetermined grouping of text indicia for heat-transfer application to a garment.

5. The method of claim 4, wherein said carrier comprises horizontal and vertical gridlines for assisting with registration during said user application.

6. The method of claim 4, further comprising a seventh step of mailing said envelope with indicia to the user.
